(19) United States
(12) Patent Application Publication
(10) Pub. No.: US 2019/0121998 A1
(43) Pub. Date: Apr. 25, 2019

(54) COMPUTER SYSTEM DATA GUARD

(71) Applicant: DornerWorks, Ltd., Grand Rapids, MI (US)

(72) Inventor: Steven H. VanderLeest, Grand Rapids, MI (US)

(21) Appl. No.: 15/788,963

(22) Filed: Oct. 20, 2017

(51) Int. Cl. G06F 21/62; G06F 21/60

(52) U.S. Cl. CPC G06F 21/6227; G06F 21/604; G06F 21/602

(57) ABSTRACT

An advanced data guard with an encrypted keyword list that allows wild card constructions in the encrypted keyword list without the need to perform any decryption of the keyword list. The data guard may include a message parsing section that extracts individual words from a message, a wild card expansion section that expands each extracted message word into an expanded list of all possible wild card constructions, an encryption section that encrypts the individual message words in the expanded list to produce an encrypted list and a comparison section that compares each word in the encrypted message list against each encrypted word in the encrypted keyword list. The result of the comparison section may be presented to a rules engine to determine the appropriate action, which may include, for example, prohibiting or permitting transmission of the message, sending an alarm and/or logging the event.

### BACKGROUND OF THE INVENTION

The present invention relates to computer security and, more particularly, to data guards configured to protect against leakage of secure information.

Often a computing system transfers data and messages between networks or components or within components, with varying level of sensitivity and security of the data. In secure applications, it may be desirable to ensure certain information is not present in a message in order to prevent leakage of secure information to a non-secure network or component. The act of analyzing messages and blocking those that contain secure information is sometimes called scrubbing and the component that does the scrubbing is sometimes called a data guard. One common method of scrubbing is to check the message for keywords that signify the content has high sensitivity, such as classified information, and if so, to block transmission of the message. The most straightforward implementation of keyword checks is to have a list of keywords stored in the data guard against which the message words are compared. However, this means that a malicious user that gains access to the data guard might obtain the list of keywords, which itself might be sensitive.

One way to avoid this problem is to store the keywords in the data guard in encrypted form. The message words are then encrypted with the same encryption key and compared to the encrypted keyword list for a match. Neither the plain text (decrypted) version of the keywords nor the decryption key are ever present on the data guard, yet the data guard can identify, flag, and/or block messages that contain the key words. Thus, a malicious user gaining access to the data guard cannot determine the actual keywords or message content. While encryption provides advantages, encrypting the keyword list prevents wild card searches. Wild card searches allow checking for a set of words that match a pattern. For example, if the keyword “gr*d” was used where “*” could represent zero or more alphabetic characters, this would then match the word “grid”, “greed”, “grad”, etc. The inability to implement wild card searches can limit the functionality of the data guard and have a significant negative impact on the resources required by the data guard. For example, the inability to implement wild card searches may require the data guard to include an extremely long list of encrypted keywords that includes all of the words that could have been represented by a wild card construction. In some applications, the number of words that could have been represented by a wild card construction is so great that it is not practical to include all of the words in the keyword list, thereby making the functionality a practical impossibility.

### SUMMARY OF THE INVENTION

The present invention provides an advanced data guard that is capable of implementing wild card searching in the context of an encrypted keyword list without the need to perform any decryption of the keyword list. In one embodiment, the data guard includes a message parsing section that extracts individual words from a message, a wild card expansion section that expands the extracted word into a plurality of wild card constructions, an encryption section that encrypts the plurality of wild card constructions and a comparison section that compares the encrypted word and each encrypted wild card construction with the encrypted words in the keyword list. In one embodiment, the data guard includes a keyword list in which individual keywords may include wild card constructions.

In one embodiment, the data guard may be arranged to receive all outgoing messages from a security domain, such as an individual component, a subcomponent, network, a subsection of a network, and be provided with the authority to continue the transmission of messages that do not contain a word in the keyword list or to prevent transmission of messages that do contain a word in the keyword list. The data guard may be disposed as a gatekeeper along an outgoing data bus or other outgoing data link for the security domain. In a typical application, the security domain will be configured so that all outgoing messages are required to pass into the data guard for analysis before the message can be transmitted from the security domain. The encrypted keyword list may be generated in a secure environment from the plain text (unencrypted) keywords in a secure environment and then pre-configured into the data guard before it leaves the secure environment, is installed in the field, and begins operation in monitoring messages. The data guard may take a variety of alternative forms. For example, the data guard may be a router, a switch, a server, a cloud-based network of servers, a partitioned software function, a virtual machine, or essentially any other hardware/software combination capable of performing the gatekeeper role or communications associated with a security domain.

In one embodiment, the message parsing section may be configured to receive an unencrypted message in which individual words are separated by a word separation character, such as a space. The use of the space character is exemplary and any other symbol or combination of symbols or data could be used to specify the boundary between words. The message parsing section may parse through the message extracting each individual word as separated by the word separation character. The use of word separation characters is exemplary and the data guard may be implemented with other mechanisms for delineating words within a message or otherwise allowing individual words to be extracted. In alternative applications, the message parsing section may be configured to parse on other than a single-word basis. For example, the message parsing section may be configured to parse on individual words and adjacent word pairs. In alternative applications, the message parsing section may be configured to parse on overlapping or non-overlapping fixed-length subsets of characters within the message.

In one embodiment, the wild card expansion section may be configured to expand each extracted message word into all possible wild card constructions. For example, the wild card expansion section may implement a recursive algorithm for generating a list of words containing all possible wild card constructions. In one embodiment, the wild card expansion section includes specified wild card expansion rules that are applied consistently during wild card expansion and during generation of the wild card constructions incorporated into the keyword list. The wild card expansion section may implement a predetermined wild card algorithm. For example, the implemented algorithm may include a wild card character that represents zero of more alphanumeric characters (or other character sets). To illustrate, with “*” used as a wild card, the message word “grid” would be expanded into “grid”, “*grid”, “grid*”, “gri*”, “gr*d”, “g*id”, “*rid”, “gr*”, “g*d”, “*id”, “g*” and “*d”. Depending on the wild card algorithm, the list may exclude prefix and suffix wild cards, such as “*grid” and “grid*”. The wild card expansion section may alternatively or additionally implement a single character wild card, which represents any single alphanumeric character (or character from another character set). The wild card expansion section may alternatively use regular expressions or other computer programming methods that define a sequence of characters to define a search or match pattern. For example, “?” indicates exactly 1 character, “*” indicates zero or more characters, “[a-d]” indicates any of the characters “a”, “b”, “c”, or “d”, and so forth. In these cases, each possible combination may be incorporated on each message word. For example, if “?” alone is used as a wild card character in the keyword list, then the message word “grid” would be expanded into “?grid”, “grid?”, “?rid”, “g?id”, “gr?d”, and “gri?”. If both “*” and “?” were used as wild card characters in the keyword list, then the message word “grid” would be expanded to “grid” “*grid” “grid*” “gri*” “gr*d” “g*id” “*rid” “gr*” “g*d” “*id” “g*” “*d” “?grid”, “grid?”, “?rid”, “g?id”, “gr?d”, and “gri?”. The wild card algorithm employed in this embodiment provides for only a single wild card character in each wild card expansion. It should be understood that, in alternative embodiments, the wild card algorithm may allow the use of multiple wild cards in a single wild card expansion, including various combinations of two or more single character wild cards and/or multiple character wild cards, such as “g??d”, “*grid*”, “*gr??” and “?r*D*”.

In one embodiment, the encryption section is configured to encrypt each word from the message and each wild card construction of that word to generate a list of encrypted words. The encryption section is configured to perform this encryption using the same encryption scheme used to encrypt the words in the keyword list. Typically, the encryption section will implement an asymmetric encryption algorithm, but the present invention may be implemented using essentially any desired encryption algorithm, including without limitation a symmetric encryption algorithm. Asymmetric algorithms may be preferred in some implementations because the encryption key is different than the decryption key, thus allowing the data guard to encrypt data without containing the key that is necessary to decrypt it. The asymmetric algorithms thus provide a stronger barrier preventing malicious access to sensitive data.

In one embodiment, the comparison section is configured to compare each encrypted word and each encrypted wild card construction generated by the encryption section against each word in the encrypted keyword list. The comparison section may implement a simple one-for-one comparison looking for exact identity, but the comparison section may implement more complex comparisons depending on the encryption algorithm.

In one embodiment, the data guard may take remedial action upon a determination that the message includes a keyword. For example, the data guard may refuse to transmit the message outside the security domain, redact the keyword from the message before it is sent outside the security domain, alter the running state of the application attempting to transmit the offending message (e.g., pause, restart or shut down), log the event and/or generate an alarm indicating that an attempt was made to send a message including a word in the keyword list.

The present invention provides a data guard that can be readily implemented in a wide range of computer systems or subsystems to allow the use of wild card constructions in the data guard keyword list. The system may implement essentially any wild card scheme provided that the scheme is implemented consistently during message word expansion and during keyword list generation. The present invention allows wild card searching without the need to decrypt the keyword list or any portion of the keyword list. That is, at all times the keyword list inside the data guard may remain completely encrypted. Even if a malicious user gains internal access to the data guard, the keyword list is protected. The system and method can include a number of optimizations to reduce resource consumption and improved speed and efficiency.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and is capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z ; and Y, Z.

### BRIEF DESCRIPTION OF THE DRAWINGS

FIG. 1 is a block diagram of a security domain incorporating a data guard.

FIG. 2 is a schematic representation of a data guard implemented as a server in a secure network.

FIG. 3 is a functional block diagram of a data guard.

FIG. 4 is a flow chart of the general steps associated with operation of the data guard.

FIG. 5 is a representation of a table representing an example wild card expansion.

FIG. 6 is a representation of a comparison of select words against an encrypted keyword list.

FIG. 7 is a schematic representation of a data guard implemented to manage the communication channel between virtual machines in a single computer.

### DESCRIPTION OF THE CURRENT EMBODIMENT

Overview.

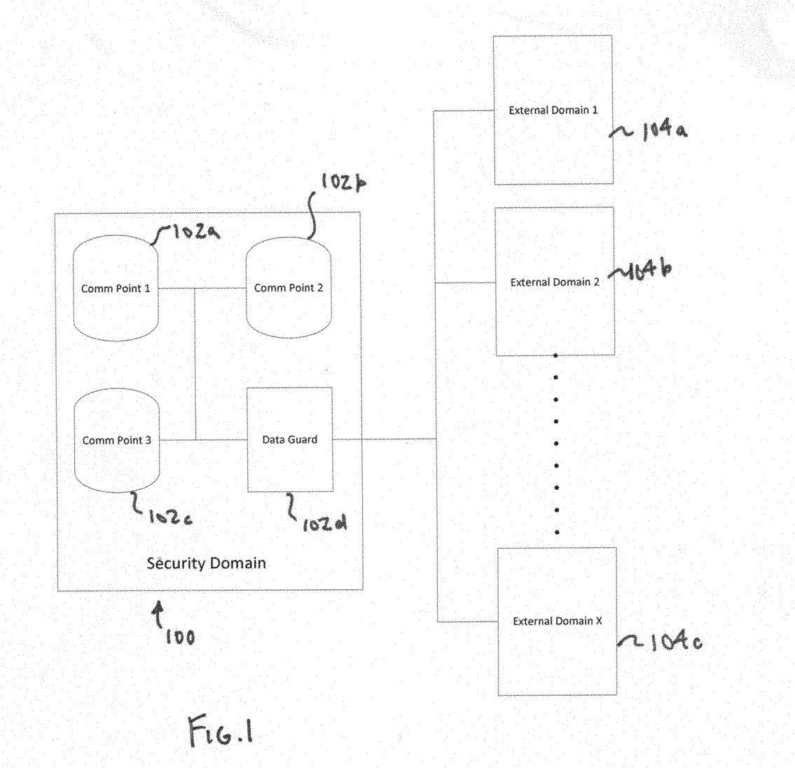

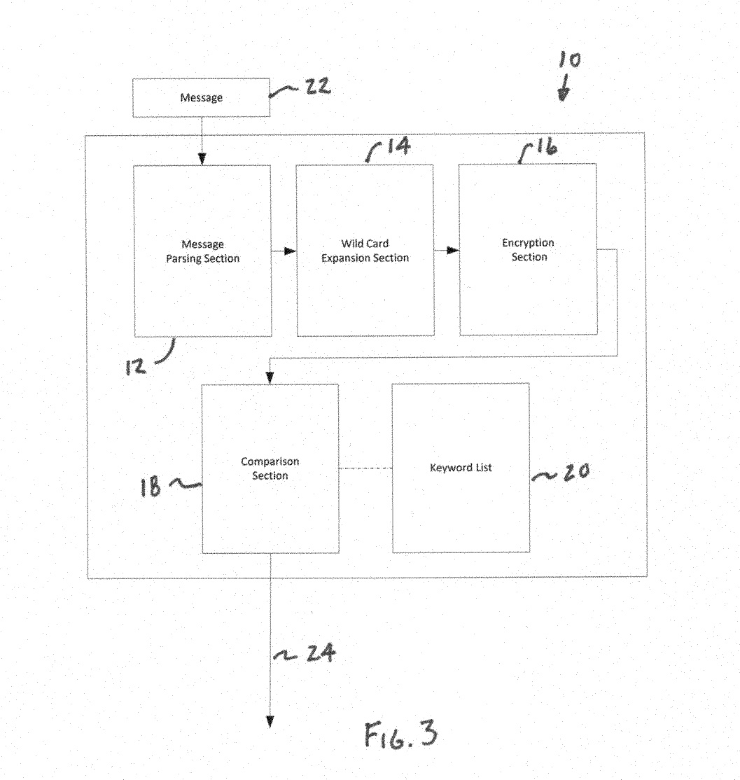

A security domain incorporating a data guard in accordance with an embodiment of the present invention is shown in FIG. 1. In this embodiment, the data guard 10 is incorporated into a security domain 100 having a plurality of communication points, such as Comm Point 1 102a, Comm Point 2 102b and Comm Point 3 102c. The security domain 100 is connected to and capable of communicating with a plurality of external domains, such as External Domain 1 104a, External Domain 2 104b and External Domain 3 104c. In this embodiment, all communications from a communication point 102a-c to an external domain 104a-c are routed through the data guard 102d. The data guard 102d is configured to monitor outgoing communications from a communication point 102a-c to an external domain 104a-c to prevent any prohibited transmission of select key words that might correspond to sensitive data. In the illustrated embodiment of the data guard of FIG. 3, the data guard 10 generally includes a message parsing section 12 that extracts individual words from a message 22, a wild card expansion section 14 that expands the extracted word into a plurality of wild card constructions, an encryption section 16 that encrypts the plurality of wild card constructions and a comparison section 18 that compares the encrypted word and each encrypted wild card construction with the encrypted words in a keyword list 20. The data guard 10 of this embodiment includes memory storing the encrypted keyword list 20. The individual encrypted keywords may incorporate wild card characters.

Data Guard System.

As noted above, the data guard 10 is provided to monitor communications from the security domain 100 to an external domain 104a-c. In the illustrated embodiment, the data guard 10 is arranged to receive all outgoing messages from the security domain 100 and has the authority to continue or prevent the transmission of messages depending on a comparison of the message with a keyword list. The data guard 10 may trigger other actions, as desired. For example, if an attempt is made to transmit an unacceptable message, the data guard 10 may prevent its transmission, may make a log entry and/or may invoke an alarm, such as an alert message to the system security administrator. The data guard 10 may be disposed as a gatekeeper along an outgoing data bus or other outgoing data link for the security domain 100. In a typical application, the security domain 100 will be configured so that all outgoing messages 22 are required to pass into the data guard 10 for analysis before the message 22 can be transmitted from the security domain 100. The data guard 10 may take a variety of alternative forms. For example, the data guard 10 may be implemented in a microcontroller, a plurality of microcontrollers, an FPGA, a plurality of FPGAs, a server, a plurality of servers, a cloud-based network of servers, a software application or a plurality of software applications, a software partition or a virtual machine, or essentially any other hardware/software combination capable of performing the gatekeeper role or communications associated with a security domain.

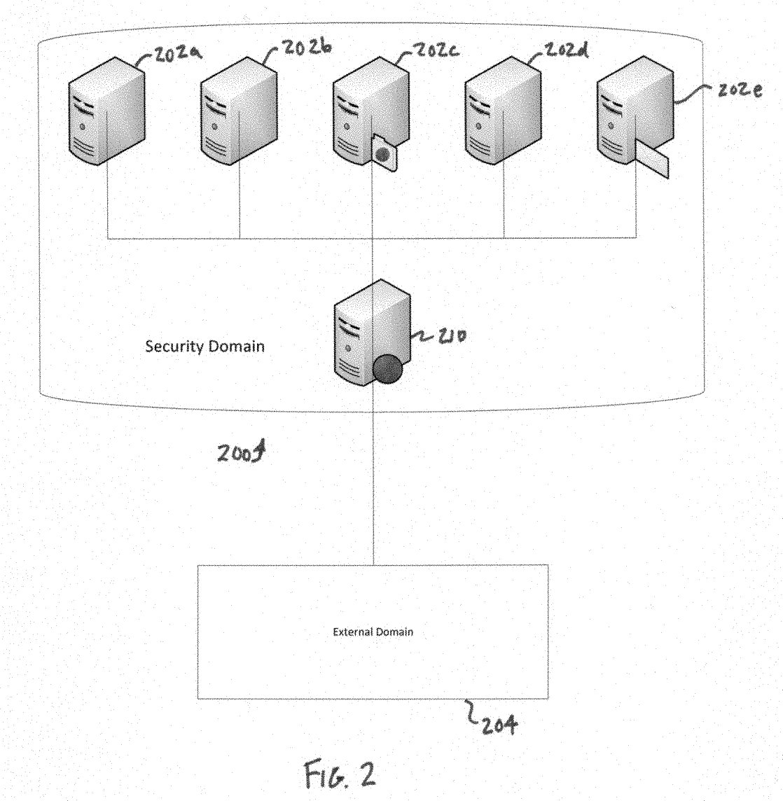

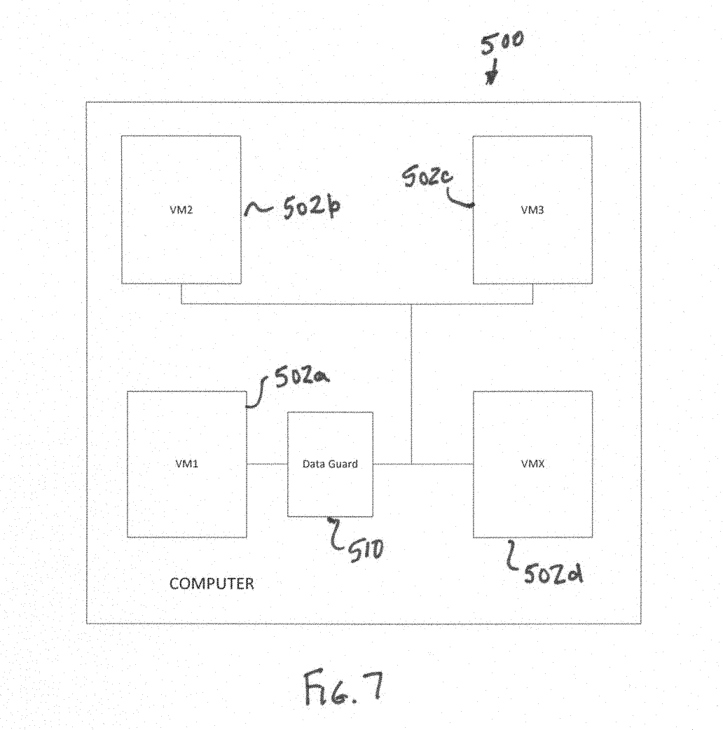

FIG. 1 is a high level representation of a computer system having a data guard that monitors outgoing communications from one secure domain. The present invention may be implemented in essentially any computer system or combination of systems in which it is desired to monitor communications between domains for the transmission of certain key words while maintaining an encrypted keyword list. In this context, the term “domain” or “security domain” are intended to be broadly interpreted to include essentially any computer resource or data set of information set that is distinct on a real or virtual level, and depending on the design or architecture, may include a network, a portion of a network, a collection of computers, a computer, a computer component, a partition, a portion of a partition, a portion of a computer component or essentially any other computer resource/portion of computer resource that is separate or capable of being separated on a real or virtual level. FIG. 2 provides a high level representation of network implementation in which the security domain is a portion of a network including a plurality of communication points in the form of discrete servers 202a-e, and the data guard is implemented on a separate server 210 though which communications from the servers 202a-e to an external domain 204 are routed. It should be understood that while FIG. 2 shows a single external domain 204, the configuration of the overall computer system may vary. For example, the system may include a plurality of external domains. Another exemplary implementation is shown in FIG. 7. In FIG. 7, the data guard 510 is integrated into a computer 500 that includes a plurality of different domains, such as different virtual machines 502a-d, that are interconnected via a communication channel. The data guard 510 of this embodiment is configured to manage the communication channel between a secure virtual machine (“VM1”) 502a and a plurality of other virtual machines (VM2-VMX) 502b-d. Although FIG. 7 shows a plurality of domains within a single computer, the data guard 510 could additionally monitor communications sent by the secure virtual machine 502a to external domains (e.g. domains not physically present in the computer 500).

As noted above, the data guard 10 generally includes a message parsing section 12 that extracts words from a message 22, a wild card expansion section 14 that expands each extracted word into a plurality of wild card constructions, an encryption section 16 that encrypts the message words and the plurality of wild card constructions and a comparison section 18 that compares the encrypted message word and each encrypted wild card construction with the encrypted words in a keyword list 20. The data guard 10 of this embodiment includes memory storing the encrypted keyword list 20. The individual keywords may include wild card constructions. It should be understood that each section may be implemented using essentially any suitable hardware and software. For example, the various sections may be implemented in a single controller/computer or they may be distributed over a plurality of controllers/computers.

In the illustrated embodiment, the data guard 10 may include a rules engine that is used to determine what action to take after a message 22 has been processed and compared with the encrypted keyword list. The rules engine may include essentially any set of criteria that is to be used to determine the appropriate action for each message. For example, the results of the comparison of the message 22 against the keyword list may be presented to a rules engine to determine the appropriate action (e.g. whether to permit the transmission, to prevent the transmission or to sound an alarm). To illustrate, the rules engine may simply prohibit transmission of any message that includes a word from the keyword list and allow any message that does not. Alternatively, the rules engine may be more complicated providing for decisions to be based on a wide range of criteria, including criteria assessed by the data guard 10 and criteria assessed by external sources. For example, the rules engine may prevent transmission of a message 22 only when the message includes two related words, the message is being sent by a user with a specific security profile and the message is being transmitted to a specific external domain. A wide range of rules engines and related criteria are known to those skilled in the field, and the present invention may be implemented with essentially any desired rules engine. The actions taken by the rules engine may include essentially any appropriate action, such as prohibiting transmission of the message, removing the offending keyword but transmitting other portions of the message, blocking the sending hardware/software from sending the current or any future messages, restarting the transmitting software, shutting down the transmitting software, sounding an alarm, causing a fault or interrupt, or any combination of these or other actions.

Although not shown, the security domain may include an encryption section that is configured to encrypt the entire message 22 prior to transmission to an external domain 104a-c. The encryption section may be invoked only after the data guard 10 had determined that transmission of the message 22 is permitted. The encryption section may be implemented using essentially any desired encryption algorithm, which can be a different algorithm from the encryption algorithm used to compare message words to the encrypted keyword list. A wide variety of suitable encryption algorithms are known to those skilled in the art. Alternatively, the message may be encrypted prior to analysis by the data guard, if the message is encrypted word by word and the encrypted keyword list was encrypted using the same algorithm.

In the illustrated embodiment, the message parsing section 12 is configured to receive an unencrypted message 22 from a communication point (e.g. communication point 102a-c) within the security domain 100. In this embodiment, the message 22 is formatted as a string of characters with individual words separated by a word separation character, such as a space. The message parsing section 12 may parse through the message 22 extracting each individual word as recognized by the presence of the word separation character and building a word list or word queue that includes all of the words extracted from the message 22. In some applications, it may be desirable for the word separation character to be a character that is not validly used in any words within the message 22. For example, in this example, the word separation character is a space, but it may be an alternative character or character sequence. The use of word separation characters to divide words is exemplary and the data guard may be implemented with other mechanisms for delineating words within a message or otherwise allowing individual words to be extracted. In alternative applications, the message 22 may be presented in a different format and the parsing algorithm may be selected to correspond with the alternative message format. For example, in an alternative embodiment, the message may be presented as a list with each element in the list being a separate word. In this alternative embodiment, words may be extracted from the message simply by parsing through the elements in the list. The list could be implemented using any of a number of known computer programming methods for handling lists of variable length strings. As another example, messages may be configured as a string of characters with each word occupying a fixed number of characters, thereby allowing words to be extracted by parsing the message into segments corresponding to the fixed word length.

In this embodiment, the message parsing section 12 is configured to extract individual words from the message 22. In alternative applications, the message parsing section may be configured to parse on other than a single-word basis. For example, the message parsing section may be configured to parse on and extract from the message both individual words and adjacent word pairs. The number of words to be extracted may vary from application to application.

In the illustrated embodiment, the message parsing section 12 may parse through the entire message 22 and generate a word list or word queue that contains all of the words in the message 22 before control passes to the wild card expansion section 14. This approach of parsing the entire message 22 before control passes may perpetuate through each section in the data guard 10. In some application, this approach allows implementation of certain optimizations and efficiencies in operation of the data guard 10 as discussed below. It should be understood that this approach, sometimes called a block method, is not necessary and the manner in which the message 22 is processed may vary from application to application. For example, in an alternative embodiment, sometimes called a streaming method, the message 22 may be processed one word at a time with control passing to the wild card expansion section 14, and sequentially through each subsequent section, on a word-by-word basis after each word is extracted from the message 22.

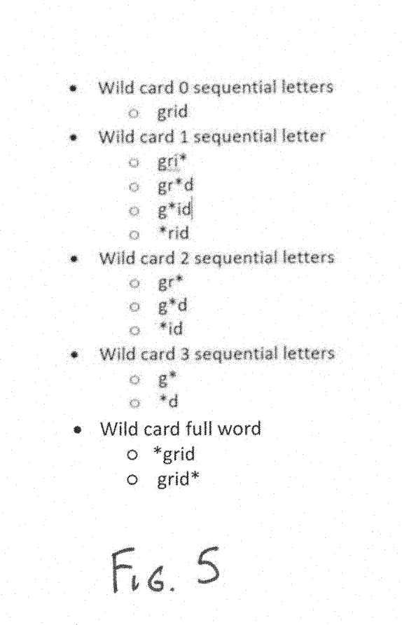

The wild card expansion section 14 is configured to expand each word extracted from the message 22 into all of its wild card constructions in a manner consistent with the way in which wild card constructions will be implemented in the keyword list. The wild card constructions might be consistent across any keyword list, could vary from one keyword list to another, could be separately configurable, or any other suitable means of statically or dynamically specifying the constructions that should be applied in the wild card expansion step. In the illustrated embodiment, the wild card expansion 14 receives a word list or word queue containing all of the individual words extracted from the message 22 by the message parsing section 12. In the illustrated embodiment, the wild card expansion section 14 implements an algorithm that moves through the word list or word queue one word at a time generating an expanded list or expanded queue that contains all of the original message words plus all of the wild card expansions for each original message words. In this illustrated embodiment, only the “*” wild card construction is applied. The original message words may be incorporated into the wild card expanded list or expanded queue as an inherent part of the wild card expansion algorithm or as a supplemental step. If the specified wild card construction is “*” alone, then the wild card expansion section 14 may implement a recursive algorithm that generates the wild card expansions by sequentially replacing each individual letter with a wild card character, then replacing each pair of adjacent letters with a wild card character and so on until a final pass in which all letters but one are replaced by a wild card character. Depending on the desired approach, the wild card expansion may also include a complete version of the word with a wild card character in front of the complete word and/or a complete version of the word with a wild card character at the end of the word. The wild card expansion character may be a character that is not normally used in message words, but that is not strictly required. In the illustrated embodiment, the wild card character is an “*”, but it can be an alternative character or sequence of characters, which would use a suitable algorithm, which might be recursive. FIG. 5 is a representation of the results of an exemplary wild card expansion algorithm applied to the message word “grid.” In this wild card expansion algorithm, the wild card character is inserted into the word “grid” in place of each zero or more characters and the resulting wild card expansion is added to the wild card construction list or queue. With reference now to FIG. 5, the wild card expansion may include the complete word “grid” in which the wild card character (e.g. “*”) is not inserted; the wild card expansions of “gri*”, “gr*d”, “g*id” and “*rid” are generated and added to the list representing with the wild card character replacing each 1 sequential letter; the wild card expansions of “gr*”, “g*d” and “*id” are generated and added to the list representing with the wild card character replacing each set of 2 sequential letters; and the wild card expansions of “g*” and “*d” are generated and added to the list representing with the wild card character replacing each set of 3 sequential letters. Although not shown, the wild card expansion may also include “*grid” and “grid*” in applications where it is desirable to allow the word “grid” to be captured by a keyword list entry of either “*grid” or “grid*”. It should be understood that this particular wild card expansion algorithm is merely exemplary and that it may be replaced by essentially any alternative wild card expansion algorithm that corresponds with the wild card expansion rules used when generated wild card expansions in the keyword list. For example, the algorithm may include single character wild card in addition to or as an alternative of a multiple character wild card. As another example, the data guard 10 may be adapted to implement multiple-word wild card construction expansions by the wild card expansion section 14 to allow multiple-word wild card expansions to be implemented in the keyword list. The wild card algorithm of FIG. 5 illustrates the use of a wild card algorithm in which a single wild card character (“*”) represents zero or more characters, and each wild card expansion includes no more than one wild card character. In alternative embodiments, the wild card algorithm may vary. For example, the wild card algorithm may alternatively or additionally allow for the use of a wild card character (“?”) that represents any single character. In some alternative embodiments, the wild card algorithm may allow the use of multiple wild cards in a single wild card expansion, including various combinations single character wild cards and/or multiple character wild cards, such as “g??d”, “*grid*”, “*gr??” and “?r*D*”.

In the illustrated embodiment, the encryption section 16 is configured to individually encrypt each of the words in the expanded list or expanded queue. As noted above, this list or queue will generally include all of the message words and all of the wild card constructions of the message words. The encryption section 16 of the illustrated embodiment is configured to implement essentially the same encryption algorithm used to generate the encrypted keyword list. Typically, the encryption section will implement an asymmetric encryption algorithm, but the present invention may be implemented using a symmetric encryption algorithm in some applications. Asymmetric algorithms may be preferred in some implementations because the encryption key is different than the decryption key, thus allowing the data guard to encrypt data without containing the key that is necessary to decrypt it. The asymmetric algorithms thus provide a stronger barrier preventing malicious access to sensitive data. In operation, the encryption section 16 may, for each word in the expanded list or expanded queue, implement the general steps of extracting a word from the expanded list or expanded queue, encrypt the extracted word and add the encrypted word to the encrypted word list or encrypted word queue. In this embodiment, the encryption section 16 parses the entire expanded list or expanded queue to generate a complete encrypted list or encrypted queue before control passes to the comparison section 18. In alternative embodiments, the encryption section 16 may process the expanded list or expanded queue one word at a time and pass each encrypted word to the comparison section 18 for further processing.

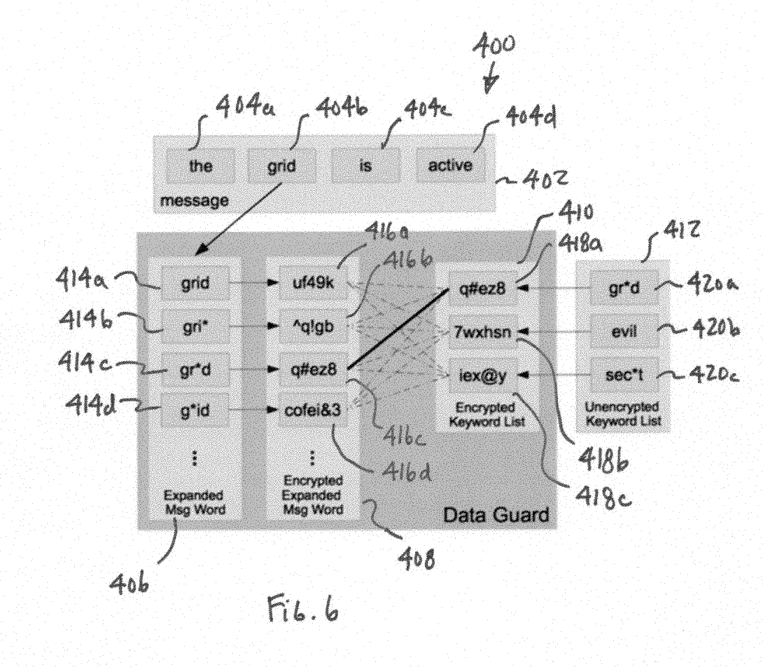

The comparison section 18 is configured to compare each word in the encrypted message word list or queue to all of the words in the encrypted keyword list 20 to determine whether that encrypted messsage word is present in the encrypted keyword list 20. FIG. 6 is a high level representation of an example implementation processing the message “the grid is active” shown at 402. In this example, each word in the message 402 is extracted by the message parsing section 12 as represented by the separation of the message words into individual boxes 404a-d. For each word 404a-d in the message 402, an expanded list of wild card constructions is generated by the wild card expansion section 14. To illustrate, a portion of the wild card expansion 406 for the message word “grid” 404b is shown including wild card constructions 414a-d. The encryption section 16 encrypts each word 414a-d in the expanded list 406 to create an encrypted list 408 that includes an encrypted representation 416a-d of each word and all of its wild card constructions. To illustrate, a portion of the encrypted list 408 containing encrypted words 416a-d corresponding with the illustrated portion of the expanded list 406 is shown. The comparison section 18 compares each word 416a-d in the encrypted list 408 with each encrypted word 418a-c in the keyword list 410. In FIG. 6, the comparisons are represented by lines extending between each encrypted word 416a-d in the encrypted list 408 and each encrypted word 418a-c in the encrypted keyword list 410. The solid line represents a match and the broken lines represent non-matches. The encrypted keyword list 410 may be generated by encrypting each word 420a-c in an unencrypted keyword list 412 using the same encryption algorithm used to encrypt the words 414a-d in the expanded list 406. For example, as shown, the word “gr*d” 420a in the keyword list 412 encrypts to “q#ez8” and the word “gr*d” 414c in the expanded list 406 encrypts to “q#ez8”. Accordingly, when these encrypted words are compared, there is a match.

If a match is found, the comparison section 18 may pass control to a rules engine to determine the appropriate action, which may include prohibiting transmission of the message, invoking an alarm, logging the event, or considering other criteria before determining appropriate action. As noted above, rules engines for this purpose are generally known to those skilled in the field. The data guard 10 of the present invention may implement essentially any rules engine, including any conventional or custom rules engine that may take into consideration the presence of keywords in the message, as well as other criteria associated with the message or unassociated with the message. In the illustrated embodiment, the comparison section 18 may parse through the encrypted list or encrypted queue one word at a time, compare each message word in its encrypted form against each keyword in its encrypted form and invoke the rules engine after each instance where the encrypted message word is found to match an encrypted keyword. The comparison section 18 may, however, implement other algorithms. For example, the comparison section 18 may alternatively work through the entire encrypted message word list to determine all matches before passing control the rules engine. This alternative approach may be beneficial in applications where the rules engine may make decisions based on the presence of two or more different words from the keyword list. It should be understood that the rules engine may be implemented as part of the comparison section 18 or as a section that is separate from the comparison section 18.

As noted above, once the data guard 10 has determined that transmission of a message 22 is permissible, the data guard 10 may permit transmission of the message 22 from the security domain 100. Before transmission outside the security domain 100, the message 22 may be encrypted using essentially any desired encryption scheme. However, encryption of the message 22 is not strictly necessary. In applications where it is desirable to encrypt outgoing messages, encryption may be carried out by essentially any hardware and associated programming. For example, a message encryption section may be implemented in the data guard or in separate computer resources situated elsewhere in the computer system.

Data Guard Method.

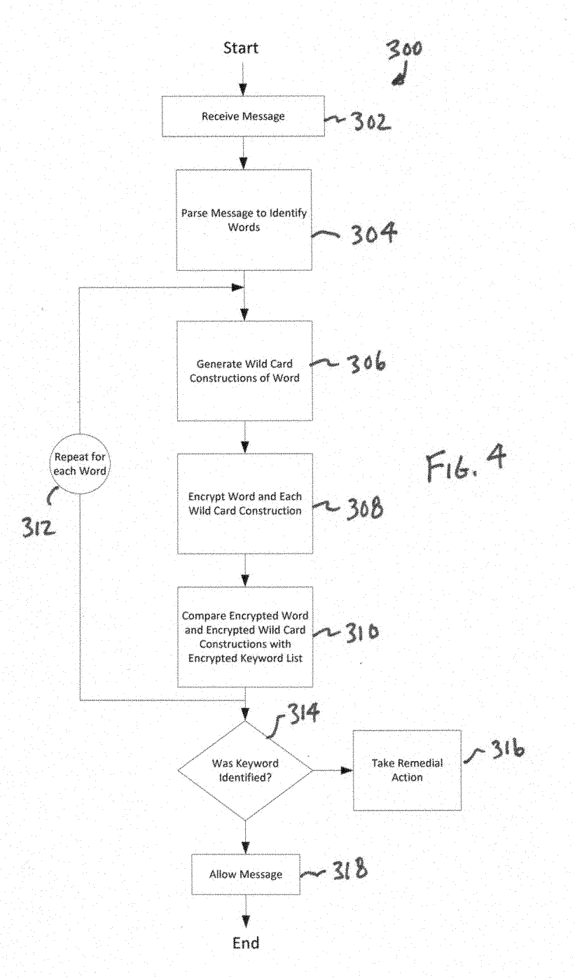

The present invention also provides a method for monitoring data using a data guard that allows the use of wild cards in the encrypted keyword list. Although the specific implementation details of the method may vary from application to application, the general steps of a method in accordance with an embodiment of the present invention are shown in FIG. 4. Referring now to FIG. 4, the method generally includes the steps of: (a) receiving a message 302; (b) parsing the message to identify individual message words 304; (c) generating the wild card constructions of each individual message word 306; (d) encrypting each message word and each wild card construction 308; (e) comparing each encrypted message word and each encrypted wild card construction with each encrypted keyword from the encrypted keyword list 310; (f) determining whether there is a match with an encrypted keyword in the encrypted keyword list; (g) if there is a match, taking remedial action of some form; and (h) if there is not match, allowing the message to pass from the data guard, for example, in the form of a transmission to an external domain.

In the illustrated embodiment, the step of receiving a message 302 may include the steps of receiving from a communication point within the security domain a message in the form of an unencrypted string of characters in which individual words are separated by a word separation character, such as a space. The format of the message may, however, vary from application to application. If desired, the message received by the data guard may be encrypted, and the data guard may decrypt the message for processing.

The step of parsing the message 304 may include the steps of parsing through the message one character at a time to identify separate words based on the presence of word separation characters within the message and building a word list containing all of the individual words extracted from the message. In alternative embodiments, the message may be presented in alternative formats and the step of parsing 304 may be modified to correspond with the message format.

In the illustrated embodiment, the step of generating wild card constructions 306 for a word may include the step of generating a list that includes the word and every possible wild card construction of that word. For example, the expanded list may include the message word and every alternative construction of the word with a wild card character in each possible location within the word. In the illustrated embodiment, the wild card character may represent 0 or more characters within the word. In alternative embodiments, other wild card character specifications or patterns might be used singly or in any combination.

The step of encrypting the expanded list 308 may include the steps of parsing through the expanded list and separately encrypting each word to generate an encrypted word list. In this embodiment, the encryption algorithm is an asymmetric encryption algorithm that corresponds with the encryption algorithm used to generate the encrypted keyword list.

The step of comparing the encrypted message word list to the encrypted keyword list 310 may include the step of comparing each individual encrypted message word in the encrypted message word list against each encrypted keyword in the encrypted keyword list. As can be seen, the comparison is made in this embodiment using two encrypted words and there is no need for the data guard to decrypt any of the words in the keyword list. This means that the keyword list can be stored in encrypted form and need not be decrypted during operation. This also means that the decryption key for the keyword list is not needed in the data guard at any time.

Symbol 312 in FIG. 4 is intended to represent that the steps of generating an expanded message word list, encrypting the expanded message word list and comparing the encrypted message word list against the encrypted keyword list are carried out for each word in the message. It should be understood that these steps need not be carried out in a separate sequence for each word in the message, but may instead be carried out in other ways. For example, the data guard may be implemented such that the entire message is parsed and a complete message word list is generated before control passes to the step of generating wild card constructions 306, the entire message word list may be expanded into a complete expanded list containing all message words and all wild card constructions of all message words in the message before control passes to the step of encrypting the expanded message list 308 and the entire expanded message list may be encrypted into a complete encrypted list of all message words and all wild card constructions before control passes to the comparison step 310.

The step of taking remedial action 316 may include passing the result of the comparison results to a rules engine to determine the appropriate action. The rules engine may implement the steps of considering the criteria presented in the rules engine and determining the appropriate action. The appropriate action may include allowing transmission of the message, prohibiting transmission of the message, sending an alarm to security administrator, sending an alarm to the sender, logging the event or essentially any other action that might be appropriate under the circumstances. Logging of the event (in either case, whether the comparison matches or not) might include accumulation of various statistics regarding messages and message words which are then used by the rules engine for future decisions.

If there are no matches or the rules engine otherwise permits transmission of the message, the method may further include the steps of encrypting the message using any desirable encryption algorithm and transmitting the message to an external domain. It should be noted that the message encryption used for transmission to an external domain may be implemented on the message as a whole and may be dissimilar from the word-by-word encryption used in the encryption step 310.

In some applications, it may be desirable to implement algorithms intended to reduce the resource consumption of the data guard, such as the computer processing power associated with the steps of parsing, expanding, encrypting and comparing carried out by the data guard. For example, in one embodiment, it may be desirable to sort the encrypted keyword list prior so that a more efficient comparison between the encrypted message word list and the encrypted keyword list can be performed. The term “sorting” is used broadly herein to refer to the implementation of conventional sorting algorithms, as well as other programming conventions for organizing data to optimize or otherwise improve the speed or efficiency of traversing or comparing data, including without limitation arranging data in numerical or alpha-numeric order, organizing data into a binary tree and organizing data into a hash table.

As another example, the data guard may be configured to limit the word list to a unique set before implementing the expansion, encryption and comparison steps. For example, in one embodiment, the message parsing section 12 may parse the entire message 22 and reduce the words for consideration to a unique set (i.e. remove repeat words so that they are not processed more than once). To illustrate, if the word “grid” is included in the message twice, it may, depending on the circumstances, need not be expanded into wild card constructions twice, encrypted twice and compared against the keyword list twice. This may be achieved by maintaining a data structure, such as a list or queue of each word parsed from the message, comparing each newly parsed word against the list and only adding the newly parsed word to the list or queue if it is not already present. To implement some of these mechanisms, it may be beneficial to parse the entire message and build a complete list or queue of words before transferring control to the wild card expansion section 14. Alternatively, efficiency may also be achieved by keeping a cache of message words that do or do not match the keyword list, maintain the cache across multiple messages. For example, one implementation would be to cache only words that do not match the keyword list, to avoid keeping a partial list of keywords present in memory in the data guard, which might be vulnerable to access by a malicious user.

Further, in some applications, a word that is a truncated version of another word in the message may be eliminated. For example, if “griddle” and “grid” are both in the message, it may in some applications be acceptable to not include “grid” in the word list. This would eliminate the processing require to expand the truncated versions of the word into wild card constructions, encrypting and comparing because the wild card expansions. This may be implemented by maintaining a data structure, such as a list or queue of words parsed from the message, and comparing each newly parsed word against the list or queue. If the newly parsed word is a truncated version of a word already in the list or queue, it can be eliminated without being added to the list. If a truncated version of the newly parsed word is already in the list, the truncated version can be removed from the list and the newly parsed word can be added to the list. To implement this mechanism, it may be beneficial to build a complete list of wild card constructions for the entire message before transitioning control to the encryption section.

As an additional or alternative option, the wild card expansion section 14 may be configured to only add unique wild card constructions to the list of words to be encrypted and compared. When a word is expanded, the system may compare each potential wild card expansion for that word with the wild card constructions for the previously expanded words and only add the new wild card expansion to the list when it is unique. For example, when a message includes the words “griddle” and “grid”, in some applications, only the first instances of “*grid”, “grid*”, “gri*”, “gr*” and “g*” may be added to the list for encryption and comparison. To illustrate, the wild card expansion section 14 may maintain a data structure, such as a list or queue of previously-generated wild card constructions for that message, compare each new wild card construction against the data structure and only add the new wild card expansion to the data structure if it is unique.

Similar mechanisms could also be implemented by the encryption section 16 or the comparison section 18. For example, the encryption section 16 may ensure that each wild card construction sent to it for encryption is not a repeat before actually performing encryption. Again, this may be achieved by maintaining a data structure, such as a list or queue of each wild card construction previously processed, comparing each new wild card construction against that data structure and only processing those that are unique. The comparison section 18 may also implement a mechanism to ensure that each encrypted wild card construction is not a repeat before comparing it with the encrypted keyword list.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A computer data guard for monitoring electronic communications from a secure domain comprising:
data storage containing a keyword list of encrypted words, each of said encrypted words being encrypted using a first encryption scheme, at least one of said encrypted words being an encrypted version of an underlying word having a wild card character in accordance with a first wild card algorithm;
a message parsing section configured to extract words from an electronic message;
a wild card expansion section configured to expand each of said extracted words into a plurality of wild card constructions using said first wild card algorithm;
an encryption section configured to encrypt said plurality of wild card constructions using said first encryption scheme;
a comparison section configured to compare each of said encrypted wild card constructions with said keyword list of encrypted words; and
a remedial action section to initiate remedial action when at least one of said encrypted wild card constructions is present in said keyword list of encrypted words.

2. The data guard of claim 1 further including a communication channel through which all electronic message from said secure domain pass, said data guard being disposed along said communication channel, whereby said data guard receives all electronic messages from said secure domain prior to transmission to another domain.

3. The data guard of claim 1 further including a transmission section to transmit or permit to be transmitted said electronic message upon a determination by said comparison section that none of said encrypted wild card constructions is present in said encrypted keyword list.

4. The data guard of claim 3 further including an encryption section to encrypt said electronic message prior to transmission by said transmission section.

5. The data guard of claim 1 wherein said data storage containing said keyword list is nonvolatile storage.

6. The data guard of claim 4 wherein said first encryption algorithm is an asymmetric encryption algorithm.

7. The data guard of claim 6 wherein said remedial section includes a rules engine containing a plurality of rules from which said remedial section determines said remedial action.

8. A method for implementing a data guard, comprising the steps of:
maintaining an encrypted keyword list containing a plurality of keywords in an encrypted format, the encrypted keywords encrypted using a first encryption scheme, at least one of the keywords including a wild card character;
parsing an electronic message to extract words from the electronic message;
expanding the extracted words into a plurality of wild card constructions;
encrypting each wild card construction into an encrypted wild card construction using the first encryption scheme;
comparing each encrypted wild card construction with the encrypted keyword list without decrypting the encrypted wild card construction or the keyword list; and
taking remedial action in response to determining that an encrypted wild card construction is present in the encrypted keyword list.

9. The method of claim 8 wherein said parsing step includes extracting words from the electronic message based on a word separation character.

10. The method of claim 9 wherein said expanding step includes expanding each extracted word into all possible wild card constructions permitted by a wild card algorithm; and
wherein the at least one keyword included a wild card character incorporated into the keyword in accordance with the wild card algorithm.

11. The method of claim 10 wherein said expanding step includes building a list of all of the wild card constructions for all of the extracted words; and
wherein said encrypting step includes building a list of encrypted wild card constructions including all of the wild card constructions for all of the extracted words.

12. The method of claim 11 wherein said comparing step includes comparing each of the encrypted wild card constructions against the keyword list to identify all of the encrypted wild card constructions present in the keyword list, said comparing step occurring without decrypting any of the encrypted wild card constructions or any of the encrypted words in the keyword list.

13. The method of claim 12 wherein said taking remedial action step includes determining a remedial action based on a rules engine.

14. The method of claim 13 wherein the rules engine includes a plurality of objective rules which direct selection of one of a plurality of alternative remedial actions.

15. The method of claim 13 wherein said alternative remedial action includes at least one of prohibiting transmission of the electronic message outside a security domain, redacting a keyword from the electronic message before the electronic message is transmitted outside a security domain, altering the running state of an application attempting to transmit the electronic message, logging the attempted transmission of the electronic message and generating an alarm indicating that an attempt was made to transmit an electronic message including a keyword.

16. A method for preventing the transmission of sensitive data from a secure domain, comprising the steps of:
establishing a data guard within the secure domain;
configuring a communication so that all electronic message to be transmitted from the secure domain are required to pass through or obtain permission from the data guard;
maintaining a keyword list containing encrypted representation of the sensitive data; the encrypted representations encrypted using an asymmetric encryption scheme, the keyword list including at least one encrypted representation of a keyword including a wild card character;
parsing an electronic message in the data guard to extract portions of the electronic message;
expanding each of the extracted portions into a plurality of wild card constructions, the wild card constructions for a given extracted portion including all possible wild card constructions using a first wild card algorithm;
encrypting each wild card construction into an encrypted wild card construction using the asymmetric encryption scheme;
comparing each encrypted wild card construction against the encrypted keyword list without decrypting the encrypted wild card construction or the keyword list; and
preventing transmission of sensitive data from the secure domain in response to determining that an encrypted wild card construction is present in the encrypted keyword list.

17. The method of claim 16 wherein said keyword list is maintained in the data guard.

18. The method of claim 17 wherein said parsing step includes separating the electronic message into separate words, the electronic message being provided as a character string in which words are separated by a word separation character.

19. The method of claim 16 further including the step of sorting the keyword list.

20. The method of claim 16 further including the step of eliminating duplicate extracted portions of the electronic message before said expanding step.

21. The method of claim 16 further including the step of eliminating duplicate wild card constructions before said encryption step.

22. The method of claims 16 further including the step of eliminating duplicate encrypted wild card constructions before said comparing step.
